(19) United States
(12) Patent Application Publication
(10) Pub. No.: US 2008/0098901 A1
(43) Pub. Date: May 1, 2008

(54) COFFEE MILL

(75) Inventor: Kwok Kay LEE, Kwun Tong (CN)

Correspondence Address: LEYDIG VOIT & MAYER, LTD, 700 THIRTEENTH ST. NW, SUITE 300, WASHINGTON, DC, 20005-3960, US

(73) Assignee: MAIN POWER ELECTRICAL FACTORY LTD., Kwun Tong (HK)

(21) Appl. No.: 11/552,628

(22) Filed: Oct. 25, 2006

(51) Int. Cl. A47J 31/42

(52) U.S. Cl. 99/286

(57) ABSTRACT

A coffee grinder has a lower body with an opening for receiving coffee beans and a removable coffee bean container mounted on the lower body. The container has a discharge opening which, in situ, communicates with the opening in the body. A grinder is located in the body in communication with the opening for grinding coffee beans into smaller coffee grounds. A closure is located with the coffee bean container for selectively closing the discharge opening when required.

### BACKGROUND TO THE INVENTION

1. Field of the Invention

The present invention relates to coffee mills and to coffee bean storage. More particularly, the current invention relates to a coffee mill incorporating a coffee bean storage container.

2. Background Information

Coffee mills for grinding coffee beans into smaller coffee grounds is well-known. Such devices comprise a container for holding coffee beans and a rotary coffee grinding head located below a discharged opening of the container. A chute directs coffee grounds from the grinding head to a removable grounds collection container.

Ideally coffee beans should be kept in a sealed container to avoid spoiling or staling of the beans. Beans left in the bean container of known coffee mills will spoil or stale because in known devices those containers are not sealed. The container may have a lid to prevent foreign matter entering the container but the lid is typically not a sealed lid and furthermore air may enter the container through the discharged opening to the grinder head.

### SUMMARY OF THE INVENTION

Accordingly, is an object of the present invention to provide a coffee mill having a coffee bean container that can be closed-up to ameliorate spoiling or staling of the coffee beans, or which is at least an improvement over known coffee mills or provides the public with a useful alternative.

In view of the forgoing, there is disclosed herein a coffee mill comprising a body having an opening for receiving coffee beans into the body, a grinder located in the body and communicating with the opening for grinding coffee beans into smaller coffee grounds, a removable coffee bean container located on the body and having a discharge opening, the discharge opening communicating with the opening in the body, and a closure located with the coffee bean container to close the discharge opening when required.

Preferably, the container has a floor that is funnel-shaped with the discharge opening located at a lowest part of the floor.

Preferably, the container further comprises a rotary shaft wherein the closure is attached to the shaft for movement between open and closed positions by rotation of the shaft, respectively closing the discharge opening in the closed position and opening the discharge opening in the open position.

Preferably, the coffee mill further includes a closure motor located in the coffee mill body for selectively rotating the shaft when the coffee bean container is located on the body.

Preferably, the rotary shaft is coaxial with the discharge opening and the closure is coaxially mounted on the shaft.

Preferably, the closure is in a threaded engagement with the shaft for axial movement long the shaft when the shaft rotates.

Preferably, the closure is bell shaped and has a lower edge that engages with a periphery of the discharge opening to close the discharge opening.

Preferably, the coffee mill further includes a conical deflector located in the coffee bean container above the discharge opening and closure.

Further aspects of the invention will become apparent from the following description.

### BRIEF DESCRIPTION OF THE DRAWINGS

An exemplary form of the present invention will now be described by way of example only and with reference to the accompanying drawings, in which:

FIG. 1 is a perspective depiction of a coffee mill according to the invention,

FIG. 2 is a partially exploded depiction of the coffee mill,

FIG. 3 is a section depiction through a coffee bean container of the coffee mill,

FIG. 4 is a section depiction of the coffee bean container arranged with a grinder mechanism, in which beans may enter the grinder,

FIG. 5 is a section depiction of the coffee bean container arranged with the grinder mechanism, in which the container is closed-up, and

FIG. 6 is a schematic depiction of the internal mechanism of the coffee mill.

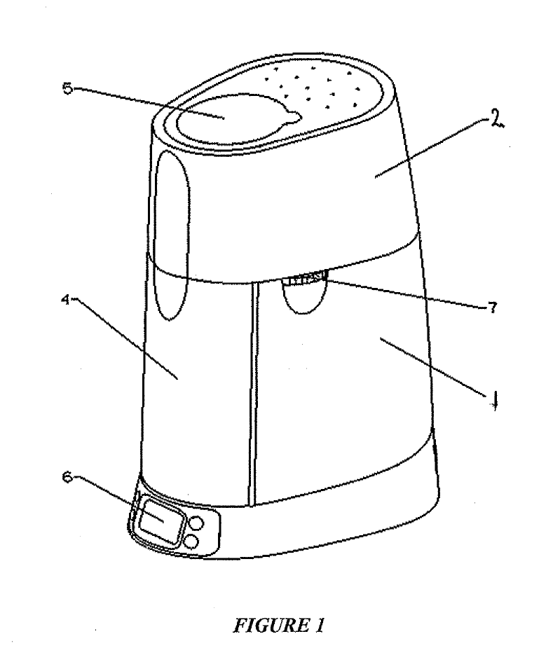

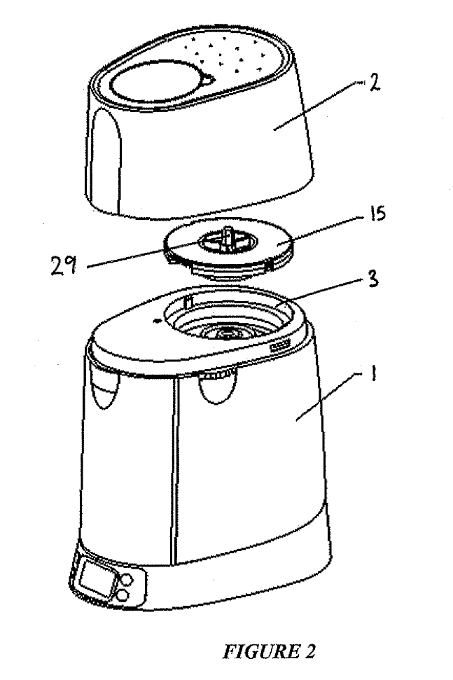

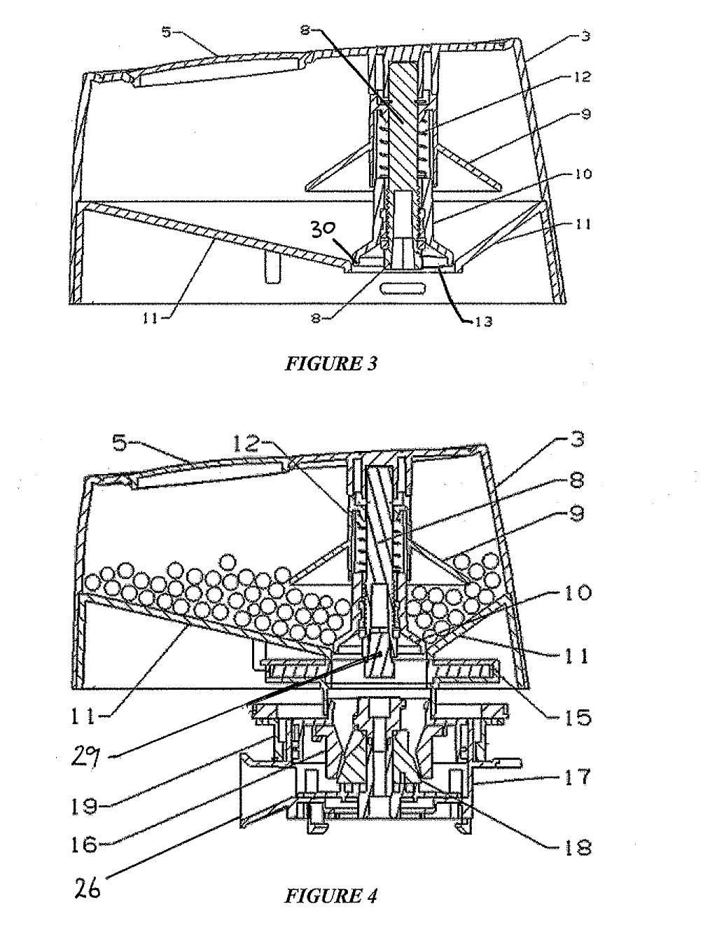

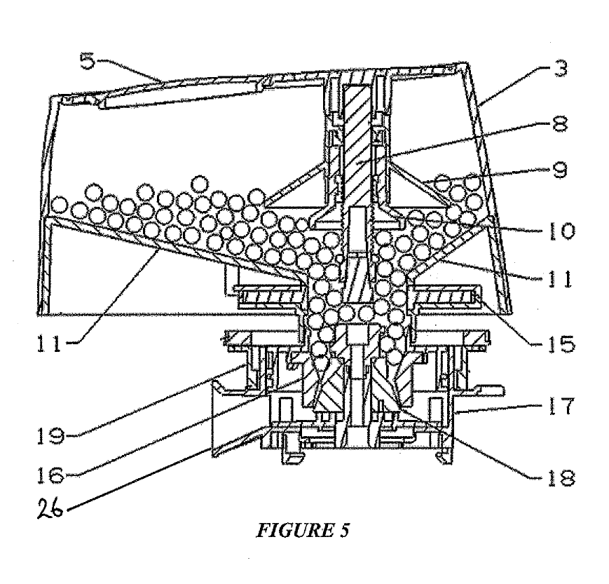

### DESCRIPTION OF THE EXEMPLARY EMBODIMENTS

In the drawings there is depicted a coffee mill incorporating a coffee bean storage container which can be closed-up in order to ameliorate spoiling or staling of stored coffee beans. The coffee bean container can be removed from the coffee mill for storage separately to the coffee mill body.

The coffee mill comprises a coffee mill body 1 having removably mounted thereon a coffee bean storage container 2. The coffee mill body 1 includes an upper opening 3 into which coffee beans can be received from the container 2. Communicating with the opening 3 in known manner is a grinding mechanism comprising a pair of grinding burrs 16, 18 coaxially arranged on a rotational grinding shaft for grinding coffee beans into smaller coffee grounds. The grinding shaft is rotated by a grinder motor 21 through a reduction gearbox 20. A thumb-wheel 7 of the grinder partly protrudes through an opening in the side of the coffee mill body 1 for manual adjustment of the desired size of the coffee grounds. Beneath the grinder burrs 16, 18 is a grounds collection cup 17 with a chute 26 for directing ground coffee beans to a removable coffee grounds container 4 located partially within the coffee mill body 1.

Also located within the coffee mill body 1 is a controller (not shown) for starting and stopping the grinder motor 21 in accordance with user control inputs. A control input interface 6 is located at a lower base part of the coffee mill body 1 and has a display screen and several input buttons of known type for setting grinding functions of the coffee mill. An interlocking safety switch 25 is provided so that the coffee grinding mechanism cannot be operated unless the coffee bean container 2 is in place upon the coffee mill body 1.

The coffee bean container 2 comprises side and upper walls 27, 28 and a funnel-shaped floor 11. The funnel-shaped floor 11 is directed towards a discharged opening 13 at the lowest point of the floor for delivering coffee beans to the discharged opening 13. The top wall 28 of the container 2 has an opening with a sealable closure 5 for filling the container 2 with coffee beans. Extending downwardly from the top wall 28 is a flange for mounting a rotational closure-shaft 8 coaxially above the discharge opening 13. A bell-shaped closure door 10 is located about a lower part of the closure-shaft 8 for selectively closing the discharged opening 13. The closure 10 has a threaded engagement with the closure-shaft 8 so as to be moved up and down the shaft 8 by respective rotations of the shaft to open and close the discharged opening 13 as required. A spring 12 about an upper portion of the closure-shaft 8 applies a downward (closed) bias to the closure 10. In the closed position a lower edge 30 of the closure 10 engages with a periphery of the discharge opening 13 to seal the opening. Preferably, although not essentially, a sealing ring such as a rubber grommet, bush or o-ring, is used between the closure and opening periphery to provide a strong airtight seal. Attached to a lower part of the flange surrounding the shaft 8 and closure 10 is a conical deflector 9 providing protection over the closure 10 and discharged opening 13.

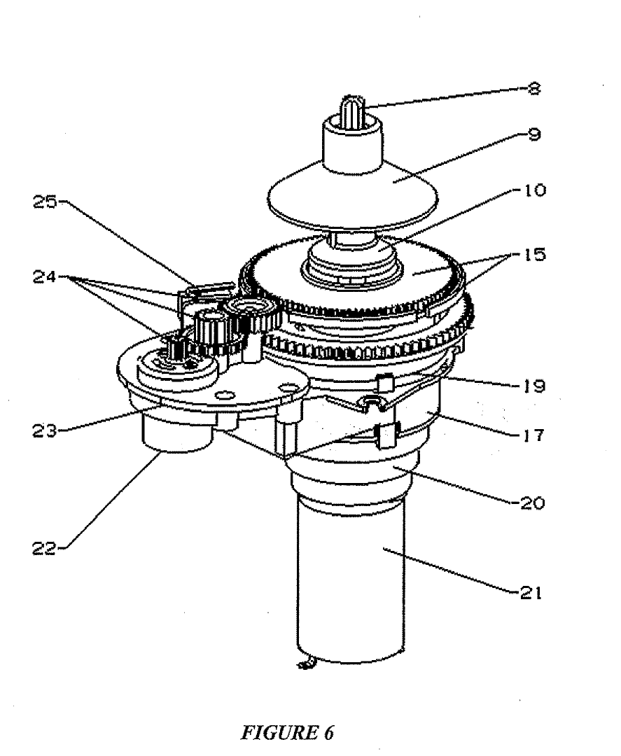

Referring specifically to FIG. 6, a collar 19 is located about an upper part of the grinder for supporting a mounting plate 23 that mounts a closure motor 22 and pinion gears 24. The output shaft of closure motor 22 is meshed with the pinion gears 24. The pinion gears 24 also mesh with the toothed outer ring of a removable coupling gear 15 that locates between the coffee mill body 1 and coffee mill container 2. The coupling gear 15 has a central spline 29 that removably couples with the closure-shaft 8 so that when the coffee bean container 2 is in place on the coffee mill body 1 operation of the closure motor 22 drives the closure-shaft 8 thereby lifting or lowering, depending on the direction of rotation, the closure 10 to open and close the discharge opening 13. The removable coupling gear 15 locates within opening 3 and has a passage between its outer toothed ring and spline 29 for movement of coffee beans thought the opening.

The coffee bean container can be filled with coffee beans through resealable lid 5. With the closure 10 closing the opening 13 the container 3 is substantially sealed to ameliorate spoiling and/or staling of the coffee beans. The container can be removed to another location that is environmentally friendly to the long term storage of coffee beans. When beans need to be ground for coffee making the container 2 can be replaced on the coffee mill body 1. There is no need for a separate storage container and transfer of beans to be ground.

In use, the container 2 must be positioned upon the coffee mill body 1 operating the safety switch 15. A user of the coffee mill inputs desired grinding parameters via input means 6. To start, the coffee mill controller operates the closure motor 22 for a short duration, say 2˜3 second, to rotate the closure-shaft 8 and raise the bean container closure 10 allowing coffee beans to pass through the discharged opening 13 and into the mouth of the grinding burrs 16 and 18. With the closure 10 raised (open) the grinder motor 21 is operated to begin grinding coffee beans to smaller coffee grounds in accordance with set parameters. Coffee grounds collect in collection cup 17 and pass down chute 26 to the removable grounds container 4. To end the milling cycle the closure motor 22 is operated in the opposite direction for a short duration to close closure 10 thereby closing-up the discharged opening 13 of the coffee bean container 2. The grinder motor 21 is operated while the closure 10 is being closed and for a further few seconds, say 3-5 second, afterwards in order to clear coffee beans below the closure 10 through the grinding burrs 16, 18.

After the grinding operation the coffee bean container is again closed-up and substantially sealed to ameliorate spoiling or staling of the coffee beans.

It should be appreciated that modifications and alternations obvious to those skilled in the art are not to be considered as beyond the scope of the present invention. For example, in the depicted embodiment the closure motor 22 couples with the closure shaft 8 via a removable coupling gear 15. However, in an alternative embodiment the motor 21 may have an output spline located remotely from the openings 3, 13 for engagement with a gear system of the container 2 that is arranged to rotate the closure shaft 8.

1. A coffee mill comprising:
a body having an opening for receiving coffee beans into the body,
a grinder located in the body and communicating with the opening for grinding coffee beans into coffee grounds,
a removable coffee bean container locatable on the body and having a discharge opening, the discharge opening communicating with the opening in the body when the container is located on the body, and
a closure located within the coffee bean container for selectively closing the discharge opening.

2. The coffee mill of claim 1 wherein the container has a floor that is funnel-shaped, with the discharge opening located at a lowest part of the floor.

3. The coffee mill of claim 1 wherein the container further comprises a shaft and the closure is attached to the shaft for movement between open and closed positions by rotation of the shaft, respectively closing the discharge opening in the closed position and opening the discharge opening in the open position.

4. The coffee mill of claim 3 further including a closure motor located in the body for selectively rotating the shaft when the coffee bean container is located on the body.

5. The coffee mill of claim 3 wherein the shaft is coaxial with the discharge opening and the closure is coaxially mounted on the shaft.

6. The coffee mill of claim 5 wherein the closure is in =a threaded engagement with the shaft for axial movement along the shaft when the shaft rotates.

7. The coffee mill of claim 5 wherein the closure is bell shaped and has a lower edge that engages with a periphery of the discharge opening to close the discharge opening.

8. The coffee mill of claim 5 further including a conical deflector located in the coffee bean container above the discharge opening and the closure.
